(19) United States
(12) Patent Application Publication
(10) Pub. No.: US 2004/0211099 A1
(43) Pub. Date: Oct. 28, 2004

(54) DISPLAY SIGN FOR STACKABLE PRODUCTS

(75) Inventors: William M. Therrell, Matthews, NC (US); Nils E. Lucander, Davidson, NC (US)

Correspondence Address: HOWREY SIMON ARNOLD & WHITE LLP, 750 BERING DRIVE, HOUSTON, TX, 77057, US

(73) Assignee: NATIONAL GYPSUM PROPERTIES, LLC, Charlotte, NC (US)

(21) Appl. No.: 10/249,622

(22) Filed: Apr. 24, 2003

(51) Int. Cl. G09F 1/00

(52) U.S. Cl. 40/124.16

(57) ABSTRACT

A display sign for displaying advertising indicia is described, comprising a front display panel, a base member, and a return leg having proximal and terminal ends. The display sign can further include an optional end tab at the proximal end of the return leg in an approximately perpendicular orientation, for increasing the stability and strength of the display sign while simultaneously eliminating sharp edges which could potentially damage the product and allowing for easy use of the sign. Such a display sign can be readily inserted into the gaps between risers separating stackable products, or can be placed on top of stackable products, allowing for the display of advertising or promotional indicia.

### BACKGROUND OF INVENTION

1. Field of the Invention

The invention relates to adjustable signs and, more specifically, to an adjustable sign system that permits the sign to be placed away from a mounting surface, wherein the supports for the sign are capable of fitting in between narrow, square or rectangular spaces or on the top surface of a commercial product. In particular, a one-piece adjustable sign system suitable for placement within confined spaces, such as the rectangular space between within pallets or between stacks of commercial products, is disclosed, wherein the sign system requires no hardware in order to be installed and used.

2. Description of Related Art

Signs, and more particularly display systems and point of purchase signs can, when properly used, be tremendously effective as marketing tools. In this regard, display signs have become both widely popular and increasingly important in all areas of retail and commercial trades.

Point-of-purchase displays and signs are currently available in a wide variety of configurations and applications. For instance, display signs can incorporate moving systems, allowing for rotation and eye-catching light displays. Alternatively, more traditional and passive display signs can be used, such as placards or overhead signs. While often these signs are well-recognized within the traditional, retail setting, they are similarly becoming more popular for use in the rapidly-growing home-improvement center retail market, as well as the large ‘warehouse-club’ types of establishments.

Many of these home improvement and warehouse-club establishments use conventional stocking and display arrangements conventional to warehouse and other storage facilities. This includes shelving systems that accept loaded pallets and palletized items onto the shelves, or define a space for a series of pallets to be loaded into for product display. For example, long, sheet-like construction materials such as wallboard, plywood, and insulated sheathing, as well as such items as bags of cement, buckets, boxes, cartons, and the like are typically displayed on pallets, with product packages of a specific number (e.g. 10) stacked together and separated by a spacer. While these pallet product-display arrangements provide an effective method of stocking, storing, and displaying items for purchase, they often do not lend themselves to the use of conventional signs or display systems. More precisely, a variety of sign systems which have proved useful in other retail markets, such as hanging signs, barcode and magnetic signs, data strip signs, holders that mount directly to the warehouse uprights, flexible extended signs, clip signs, counter-top sign holders (e.g. those signs with a base and an extended sign or sign holder) and floor signs and displays, have proven to be problematic in the warehouse setting. For example, data strips and barcode signs are typically too small to be easily noticeable, and are often mounted with adhesives, making their quick relocation difficult. Similarly, floor signs and clip signs can often hinder customer access to a product due to their size and positioning.

In addition to the above-described problems associated with pallet-type product displays, numerous other difficulties are associated with them. For example, oftentimes the quantity of material that can be stored or stocked on the shelves or on the floor itself is so large that forklifts, fork trucks, hand trucks, or similar equipment is used to elevate, place, relocate, and load a pallet or large quantities of material either to a different shelf or rack system, or directly onto a customer's vehicle for transport following purchase. Current signs often hinder the access of the equipment to the product material, and necessitate difficult maneuvering of the vehicle to access the product, or the time-consuming process of removing the ‘permanently’ mounted signs in order to achieve access to the desired product. Furthermore, typical signs in current use cannot be easily relocated with the product due to their permanent or semi-permanent mounting.

Further sign display problems arise specifically with regard to large construction and home building products, such as wallboard, plywood, foam core insulation board, bags of fertilizer, parcels of cement and the like which are stacked in ‘dead stacks’—groups of material, e.g., wallboard, that are typically 4′ tall, 48″-54″ wide, and 8′-16′ long, depending upon the material. Often times, the signs used to advertise and display these items are makeshift and non-permanent, due to the high volume of these products which are sold. Typical examples of display signs in use in the market currently include paper, cardboard, or similar signs taped, stapled, or tacked to the edges of these product stacks. Alternatively, the signs are attached in some manner, such as with tape or staples, to the pallets that are holding these products. Further variations have included ‘make-shift’ signs consisting of a 2×4 post and plywood placard nailed to the 2×4 post in a “T-shaped” configuration. This makeshift sign is then simply leaned against the product stacks. Alternatively, a similar 2×4 post-and-placard sign has been formed into an L-shaped sign and simply inserted into, but not ‘wedged’ into, the space between the pallets supporting the product. Similar variations to this L-shaped sign have included a plastic display front panel and two L-shaped plastic legs that are bolted to the front panel. The problem with such display methods arise from the high rate of purchase of these products, necessitating the movement and often time's misplacement of the makeshift signs, as well as the difficulty in changing any advertising indicia associated therewith. Attempts at maintaining the appropriate sign for the display of indicia, product information (price, composition, qualities, etc.) or promotional information rarely extends beyond the options described above. Additionally, signs such as the L-shaped plastic sign readily tip over and/or fall out of the space within the pallets in which it is inserted, and the bolts holding it together detrimentally mar the lower pieces of commercial product. While occasionally attempts are made to more permanently secure and display the indicia and product information, such as by stapling a paper advertisement to a plywood backing board having a 2×4 “post” and leaning it against the stacks of products as described above, often the desired information is lost or disposed of in the process of moving the products. Even more detrimental, in the case of directly attaching a sign to the product stack, e.g. stapling a paper display to the side of a stack of wallboard, removal of the sign necessarily damages the edges of the wallboard being displayed, compromising the integrity of the product and often times resulting in loss of profits for the retailer due to the possession of damaged merchandise. Equally as detrimental to the manufacturer of the product on display, these ‘makeshift’ signs are typically not attractive to the customer, and do not get their attention, which can lead to loss of sales revenue.

Given the relatively recent introduction of home-improvement and similar ‘product’ warehouses, the approaches to the problems described above have been relatively limited. However, several groups have attempted to address at least one of the issues mentioned concerning product displays in the warehouse sales arena.

A customizable display apparatus comprising vertically spaced apart shelves for the display of various items, such as home building products, and moveable display signs is proposed by in U.S. Pat. No. 5,624,044 (issued Apr. 29, 1997). The display signs are described as being moveable between a closed position, in which the signs obscure from view items stored on the upper shelves of the display apparatus, and an open position in which the upper shelves are accessible from the front of the display for purposes of restocking.

U.S. Pat. No. 5,803,420 (issued Sep. 8, 1998) suggests one manner of display sign and mounting system that permits a pivoting of the sign in order to permit access to the shelves on which the sign is mounted. While addressing the issues described above, this display system offers no solution to those situations when the configuration of the display or layout of the pallet racks does not permit pivoting the sign to and from the display position for access to the shelves. Similarly, U.S. Pat. No. 6,470,611 (issued Oct. 29, 2002) suggests a two-position vertically adjustable sign for mounting display media, but does not address the issue of the instances where there is no nearby shelf or rack to mount the sign to, such as the case with larger construction items like wallboard, plywood, and foam core insulation board.

A support assembly for attachment to a pallet rack is offered in U.S. Pat. No. 6,003,697 (issued Dec. 21, 1999). According to the specification, the support system involves a bracket and associated assembly that is slidably connected to a pallet rack. The sign that is attached to this system with the associated hardware can then be fixed in place, lowered, raised, or tiltably locked in place with respect to the fixed bracket. However, the flexibility of relocation of such a sign is not readily evident from the suggested support system.

Accordingly, there exists a need for a display sign system that is suitable for use with advertising-effective media, which readily permits moving or repositioning the sign systems for access to the shelves or pallets on which the products are mounted, does not require hardware for installation and use, and does not damage the products in any way. Preferably, such a sign system is positionable in a plane that is substantially vertical (parallel) to the face of the pallet or product stack, between a display position and a storage or restocking position in which the rack or pallet shelves can be accessed.

### SUMMARY OF INVENTION

The invention disclosed herein provides a sign system for displaying commercial products and their associated advertising/promotional indicia. The sign system can be removably inserted into the voids between stacked materials, and is of one-piece construction comprising a front display panel, a base member for supporting the sign, a return leg which extends upward and towards the base member for secure ‘wedging’ of the sign, and optionally an end tab to avoid jamming and to add strength and rigidity to the sign. The front display panel extends above the plane of the base member, and is suitable for the display of advertising or promotional indicia.

### BRIEF DESCRIPTION OF DRAWINGS

The following figures form part of the present specification and are included to further demonstrate certain aspects of the present invention. The invention may be better understood by reference to one or more of these figures in combination with the detailed description of specific embodiments presented herein.

FIG. 1 is a front perspective of an adjustable display system in accordance with the principles of the present invention.

FIG. 2 is top view of the display system shown in FIG. 1 after being cut from stock material but prior to being folded into its final shape.

FIG. 3 is a perspective view of an embodiment of the invention in which the base member and return leg is split.

FIG. 4 is a top plan view of the display embodiment shown in FIG. 3 illustrating how the split base and return legs fit around a support leg of a riser supporting products.

FIG. 5 is a top view of the display system shown in FIG. 3 after being cut from stock material but prior to being folded into its final shape.

FIG. 6 is a side sectional view of the display system in accordance with the present invention.

FIG. 7 is a perspective view of a display system in accordance with a preferred embodiment of the present invention.

FIGS. 8A-8H are front perspectives of several alternative embodiments in accordance with the present invention.

### DETAILED DESCRIPTION

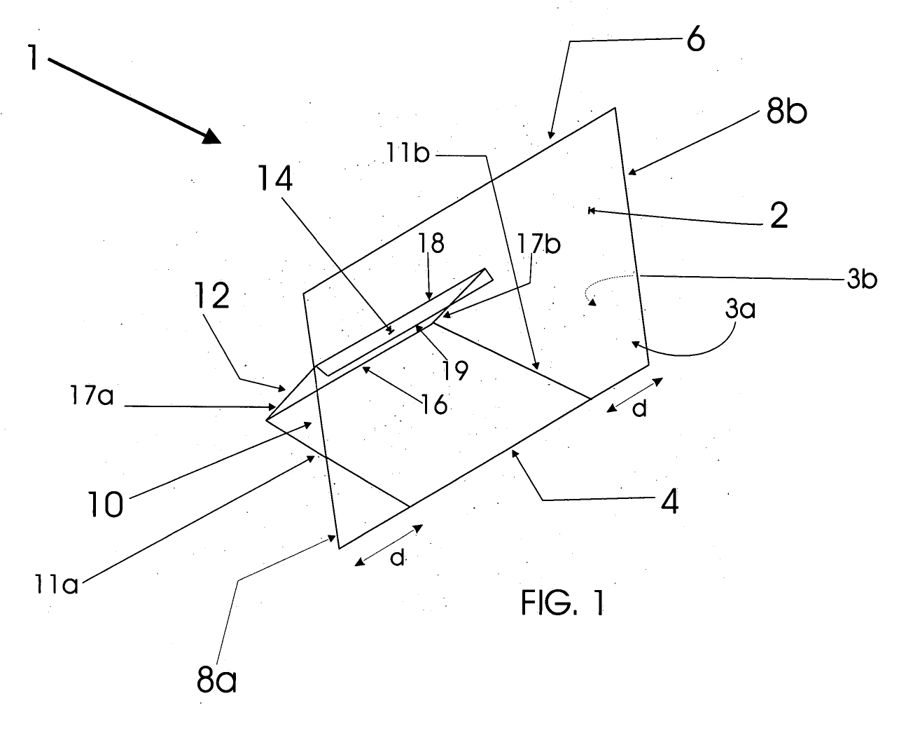

The display system of the present disclosure, as well as its alternative embodiments, is illustrated in FIGS. 1-8 as a display sign that can be removably mounted in a void between displayed products, such as in the gap between stacks of wallboard. Such a void can include the space between pallets, slots within shelving systems, slots within or between a variety of racks, and the like regardless of size, or the space between wallboard dead stacks wherein the stacks of wallboard are separated by blocks of wood, scrap wallboard, or numerous other spacing materials. When inserted into such a void, the display sign of the present invention acts as both a route to advertisement and a product display/point-of-sale avenue, while simultaneously allowing such advertisement to be placed in a multitude of locations on or near the products. For example, the display sign could be inserted into the voids of pallets which are supporting the products, thereby allowing for both product display and advertisement, as well as easy customer access to the products stacked above and around the sign. Alternatively, the display sign could be mounted on the top of a stack of merchandise, so as to be both easily visible and easy to move if necessary in order to access additional products. Because it can be removably inserted into the voids between stacks or placed on the products horizontal surface, it can be easily moved for optimum advertising effect or to add or move the products, or taken down when the store is closed. In an embodiment of the invention, the display sign is constructed of transparent material such as clear plastic so the products and/or advertising displayed thereon can be clearly viewed from any direction and/or products beyond the display sign may be clearly observed.

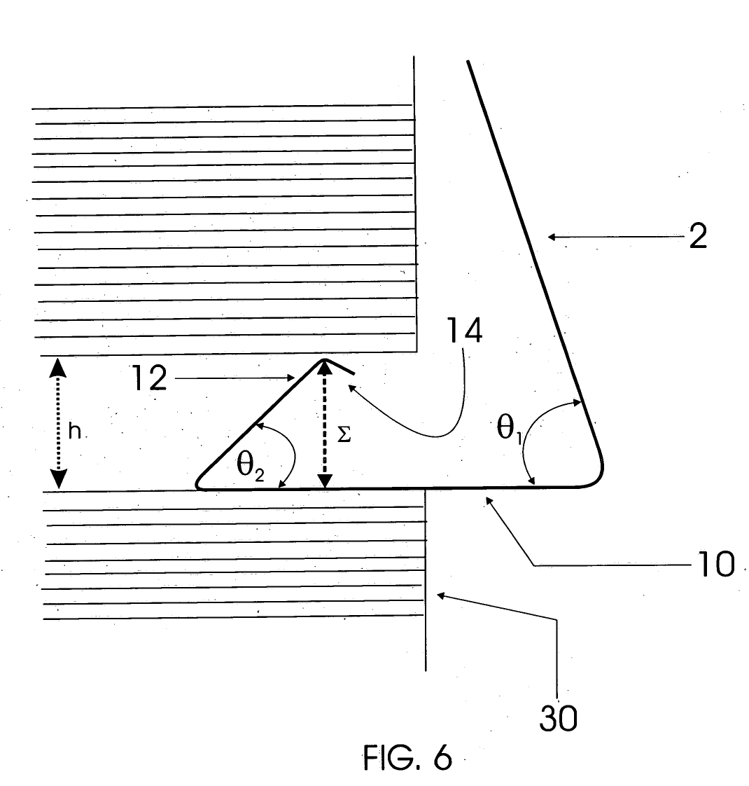

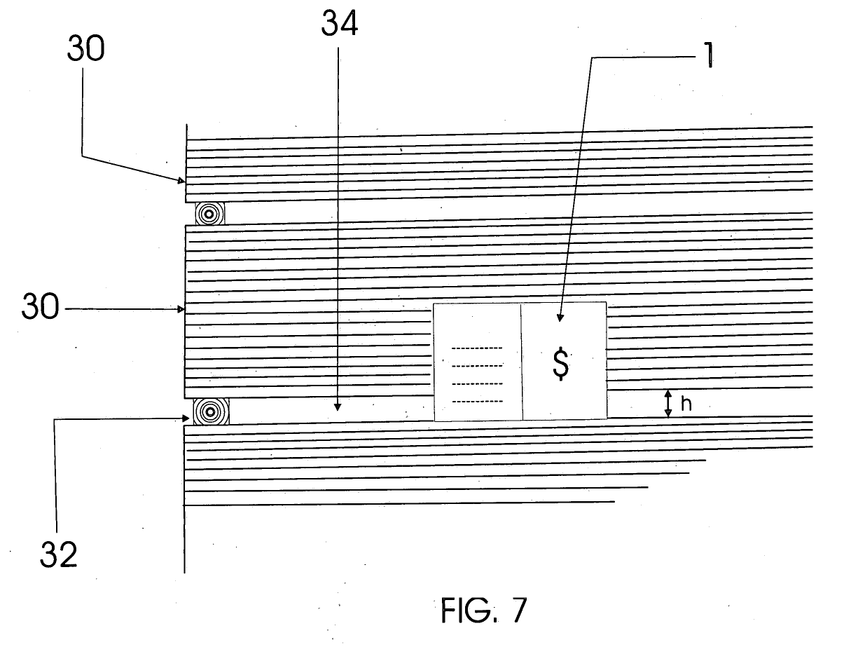

Referring now to FIGS. 1-8, a first embodiment of the display sign 1 of the present invention is generally shown. The details of this and related embodiments are described below. As used herein, the spatial descriptive terms ‘horizontal’, ‘vertical’, and ‘normal to’ have reference to the display sign 1 when it is in a typical, installed position between two surfaces, such as in the pallets supporting stacks of wallboard as illustrated in FIGS. 6-7.

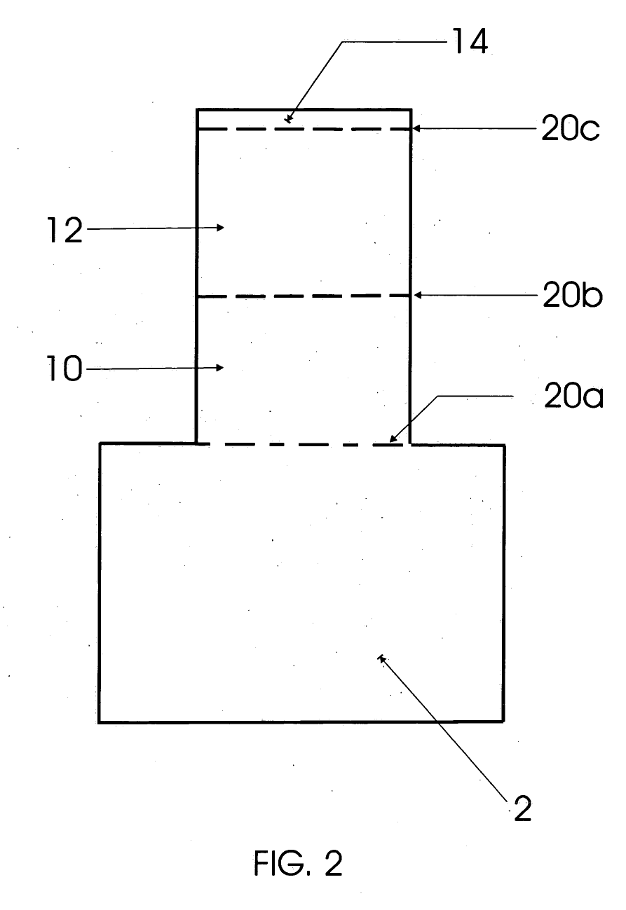

In the embodiment of the present invention illustrated in FIGS. 1 and 2 of the present invention, the display sign 1 comprises a front display panel 2, base member 10, return leg 12, and end support tab 14. As shown in FIG. 2, which affords a top-view of the display sign 1 after it has been die-cut but prior to heat-folding into its final shape, front display panel 2, base member 10, return leg 12, and end support tab 14 are connected by the edges formed at fold points 20a, 20b, and 20c. Front display panel 2 has a first front face 3a and a back face 3b. Front face 3a is in a substantially vertical plane, and is defined by bottom edge 4, top edge 6, and side edges 8a and 8b. Both side edges 8a and 8b and bottom and top edges 4 and 6 are spaced horizontally from and parallel to each other.

Front display panel 2 can be substantially perpendicular with respect to base member 10, or can be slanted inwardly toward return leg 12 in order to facilitate mounting and displaying standards, advertising indicia, or promotional information on the front face 3a. Generally, as shown in FIG. 6, the angle of the slant between front display panel 2 and base member 10 is an angle (theta)₁. Angle (theta)₁ can be any angle between about 30° and about 90°, and will depend on the nature of surroundings in which the display sign is used, as well as the size and weight of front display panel 2. Suitable angles for which can be used with the present disclosure are 30°, 35°, 40°, 45°, 50°, 55°, 60°, 65°, 70°, 75°, 80°, 85°, and 90°, and ranges between any two of these angles (e.g., any angle between about 30° and about 90°).

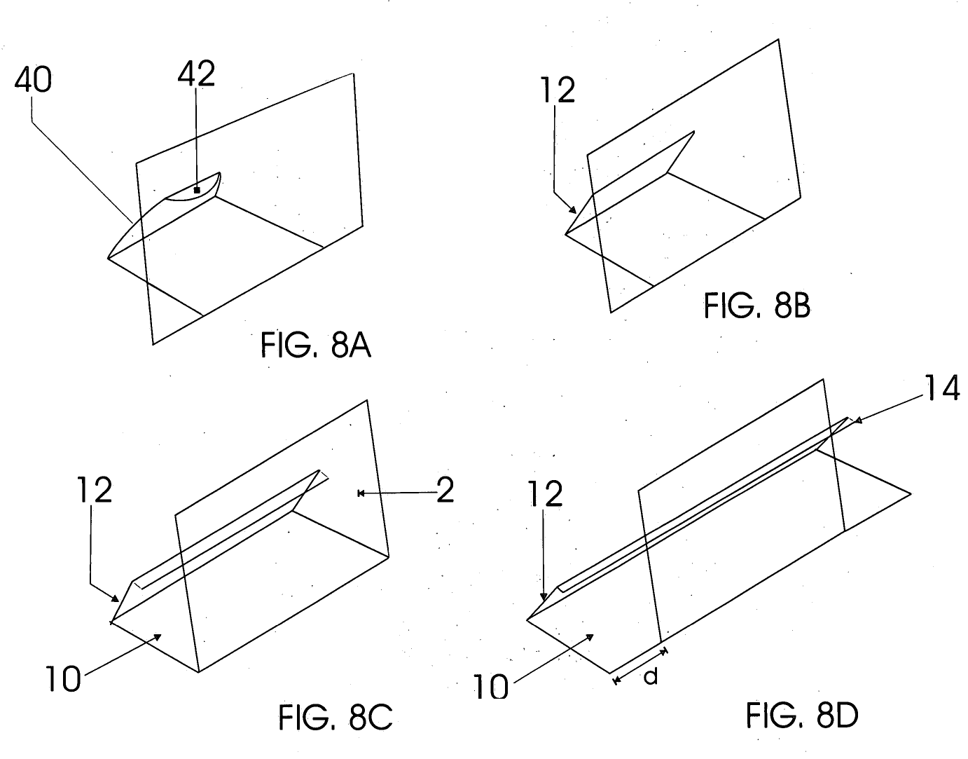

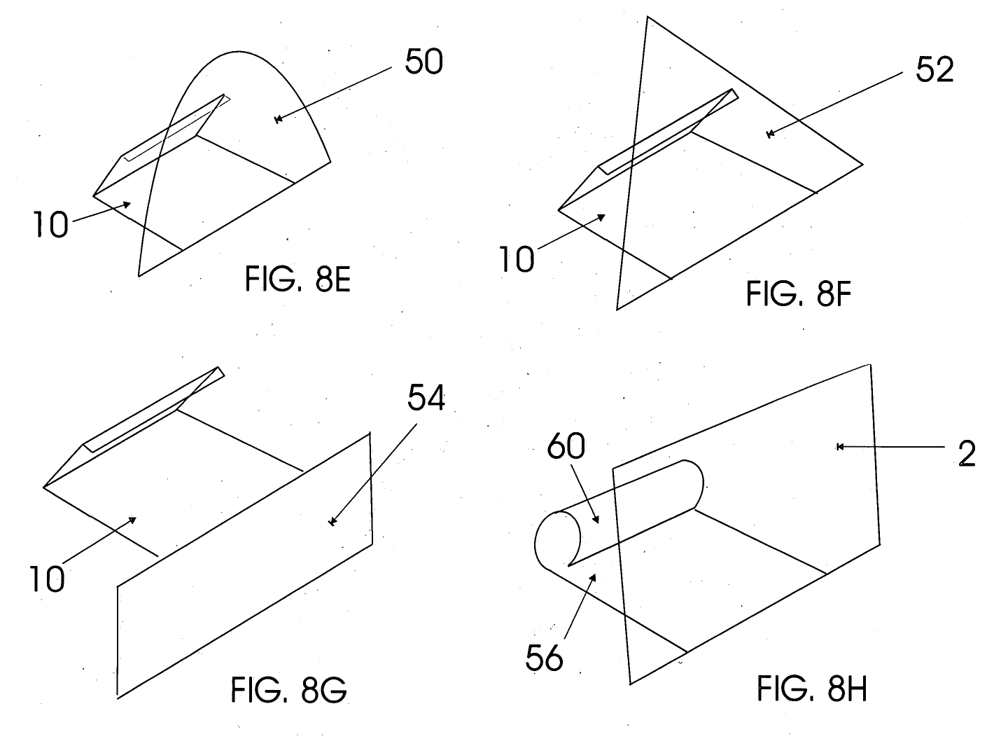

Base member 10 can be of any shape, and has both a top and bottom face, as well as a front edge, back edge 16, and side peripheral edges 11a and 11b. Base member 10, while preferably rectangular in shape, can be of another shape in order to meet particular needs, for instance to increase the area for support. Such suitable shapes include but are not limited to circular, oval, triangular, square, hexagonal, octagonal, dodecahedral, icosahedral, and freeform shapes. The front edge of base member 10 is formed by the bottom edge 4 of front display panel 2, and can be of any length. Preferably, the length of the front edge of base member 10 is less than the length of bottom edge 4 of front display panel 2. That is, as shown in FIG. 1, the front edge of base member 10 is preferably offset some distance d from the side edges 8a and 8b of front display panel 2. Distance d can be some ‘positive’ number, wherein the front display panel 2 is wider than base member 10, or d can be a ‘negative’ number wherein display panel 2 is narrower than base member 10, as illustrated in FIG. 8D. Alternatively, and equally acceptable, the base member 10 can have a front edge that is substantially the same length as the bottom edge 4 of the front display panel, wherein d is approximately ‘0’ (FIG. 8C). The back edge 16 of base member 10 is substantially parallel to the front edge and is horizontally spaced from the front edge.

Return leg 12 has a proximal end and a terminal end, 18. The proximal end of return leg 12 is the edge shared with back edge 16 of base member 10, while terminal end 18 is that end that is substantially parallel to and horizontally spaced from proximal end/back edge 16. Return leg 12 is attached to base member 10 at its back edge, 16, and is substantially the same width as edge 16. As shown in FIG. 6, return leg 12 is bent at an angle, (theta)₂, relative to base member 10, such that 12 slants toward the back face 3b of front display panel 2. Angle (theta)₂ can be any angle that is appropriate for the specific use of the display sign 1; that is, the size of the channel or gap that the display sign of the present invention will be inserted into will dictate the bend angle (theta)₂. Angle (theta)₂ can also be adjusted as appropriate depending upon the size and weight of front display panel 2. Consequently, angle (theta)₂ can be between about 1° and about 90°, and preferably between about 10° and about 80°. Suitable angles (theta)₂ for in accordance with the present invention are 1°, 5°, 10°, 15°, 20°, 25°, 30°, 35°, 40°, 45°, 50°, 55°, 60°, 65°, 70°, 75°and 80°, and ranges between any two of these angles (e.g., any angle between 10° and 80°, such as between about 40° and about 60°).

Optional end tab 14 is co-joined with the terminal end 18 of return leg 12, and is preferably joined at an angle which is substantially perpendicular to the terminal end of 12. End tab 14 is generally rectangular in shape and is defined by two edges which are substantially parallel and horizontally spaced apart, shared edge 18, and front edge 19. Shared edge 18 and front edge 19 are also substantially parallel to and horizontally spaced from each other. End tab 14 is preferably included so as to add strength, rigidity, and reinforcement to the display sign, as well as to keep shared edge 18 safer and stronger. Perhaps most importantly, however, end tab 14 is preferably included in order to increase the ease with which the display sign of the present invention can be inserted into and removed from gaps or grooves, such as those within pallets, without becoming lodged, stuck, or marring the lower surface of the material immediately above shared edge 18. Alternatively, and according to the present invention, end tab 14 can be omitted from the display sign 1, as shown in FIG. 8B. In this instance, the terminal end of return leg 12 is preferably smoothed and rounded so as to not create sharp edges and so that the product being advertised, especially soft products such as wallboard and foam core insulation board, are not marred by the now exposed terminal edge 18. Further, and equally as acceptable, end tab 14 can be of a different geometric shape other than rectangular, such as semi-circular, triangular, or free-form. Any number of shapes for end tab 14 are acceptable, being limited only in that if it is included, it necessarily must share at least one edge with the terminal edge 18 of return leg 12. One such suitable alternative in accordance with this variation of the shape of both the return leg and the end tab is shown in FIG. 8A, wherein return leg 40 is semi-circular, and end-tab 42 is also semi-circular, yet still shares one edge with the terminal edge of return leg 40.

While not intending to be limiting, a typical display sign in accordance with the present disclosure has a front face 2 having a bottom edge 4 of about 17 to about 24 inches, and a base member 10 having a width of about 9 inches co-joined with bottom edge 4 of front face 2, wherein the offset distances d are approximately 4 inches. Return leg 12 is approximately 6.8 inches in length (along edge 17a/17b). Optional end tab 14, when included, has a length along terminal end 18 of return leg 12 of approximately 9 inches, and a width of approximately ¾ inches.

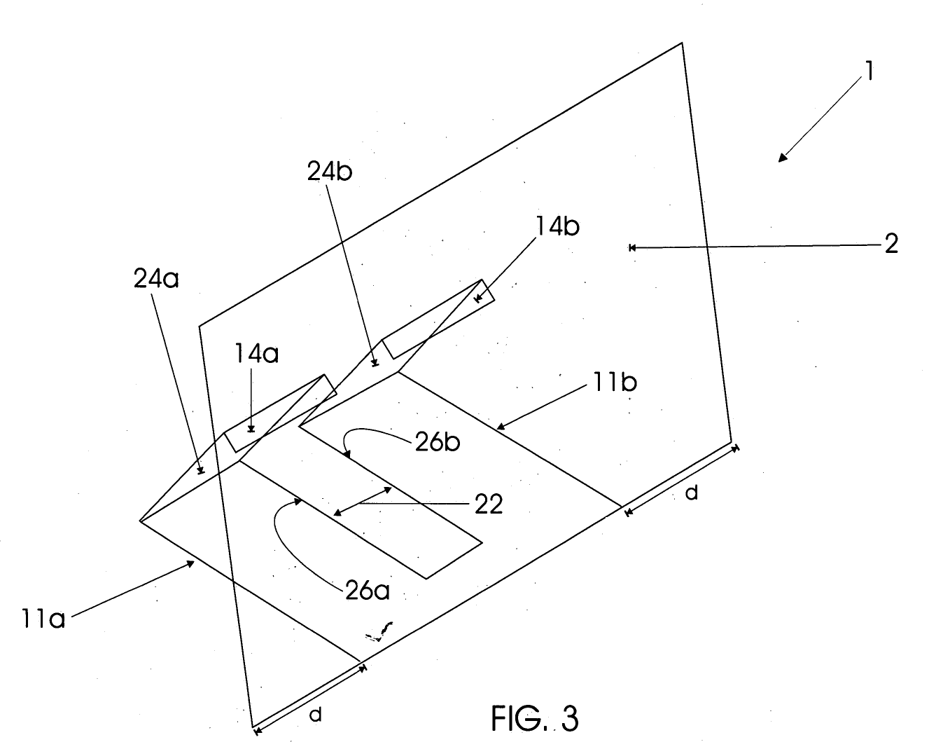

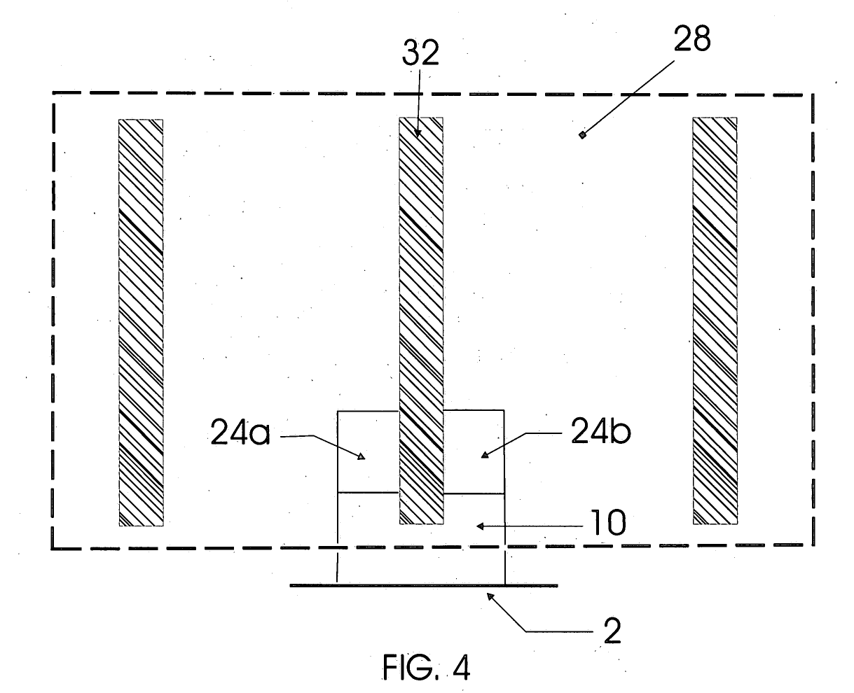

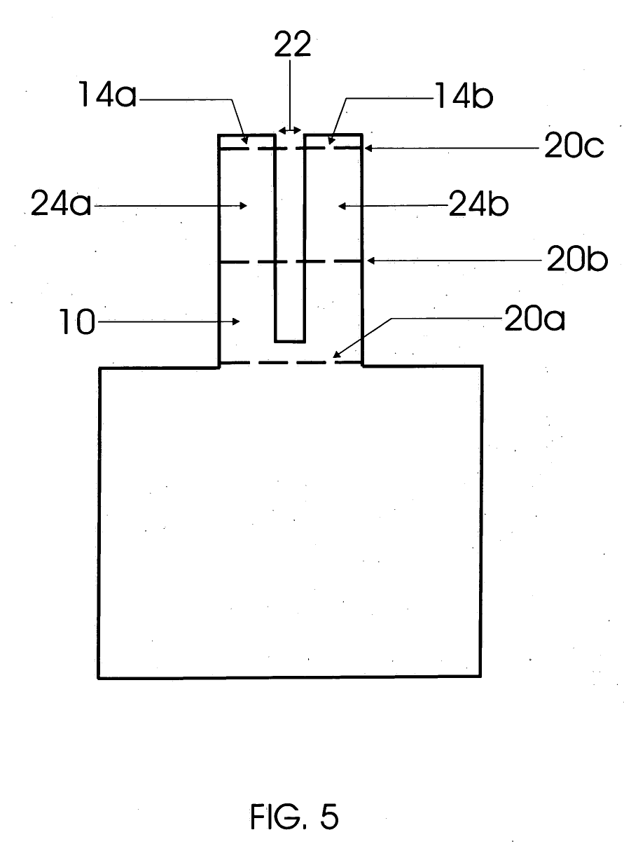

An alternative and equally acceptable embodiment of the present invention is illustrated in FIG. 3. As indicated, base member 10 can have a gap 22 in the center of it, creating interior edges 26a and 26b. Similarly, the return leg 12 described in FIG. 1 can be replaced with split return legs 24a and 24b, as shown in FIG. 3 and in the top view shown in FIG. 5. Generally, side peripheral edge 11a and interior edge 26a are substantially parallel and laterally spaced apart. Similarly, interior edge 26b and side peripheral edge 11b are substantially parallel and laterally spaced apart. Gap 22 can be of any width necessary in order for both the base member 10 and slit return legs 24a and 24b to fit around a central structure, such as around the risers supporting products for display (e.g., the center riser of a pallet). This is illustrated more clearly in FIG. 4, wherein the display sign of this alternative embodiment is inserted such that split base member 10 and split return legs 24a and 24b fit around riser 32 of pallet 28 via gap 22, allowing the display sign to be held firmly in place from both the vertical ‘wedging effect’ described above, as well as a lateral ‘pinching effect’ of the return legs 24a and 24b on riser 32.

Optionally, and equally acceptable, end tabs can be included in the embodiment illustrated in FIGS. 3 and 4. Such end tabs, 14a and 14b, are co-joined with the terminal end of split return legs 24a and 24b, and are preferably joined at an angle which is substantially perpendicular to the terminal end of legs 24a and 24b. The end tabs are generally rectangular in shape and are typically defined by two edges which are substantially parallel and horizontally spaced apart, the shared edge (terminal end) and the front edge. The shared edge and front edge are also substantially parallel to and horizontally spaced from each other. As above, end tabs 14a and 14b are preferably included so as to add strength, rigidity, reinforcement, and ease of use (insertion and removal from a pallet, for example) to the display sign.

In an exemplary method of use of the display sign of the present invention, any of the above described signs can be wedged in the gap, or channel, between two stacks of wallboard, plywood, foam core insulation, and the like having a height h. The gap h that the sign is inserted into can be that gap formed between the top and bottom of a pallet that the products are stored and displayed on, or the space between stacks of products that are separated by blocks of wood 32 or similar material. Similarly, and in accordance with the present invention, the gap can be the space between two pieces of stacked product, such as two pieces of wallboard, the slots within products themselves, slots or gaps within shelving or product display wall systems, and the like. Several of these uses are shown schematically in FIG. 6 and FIG. 7, illustrating a sign in accordance with the present invention inserted within a gap. As the base member 10 and return leg 12 of display sign are inserted into the gap, the angle (theta)₂ becomes smaller, and the distance (sigma) from base member 10 to the joint 18 between the return leg 12 and the optional end tab 14 will also become smaller. The display sign is thus held in place by a ‘wedging effect’, in that the opposing compressive pressures of the top and bottom of the gap and the expanding forces of the compressed return leg 12 serve to hold the sign firmly in place. In accordance with the present invention, and as indicated above, the angle (theta)₂ can be compressed down to almost 0°, in the case where, for example, the display sign does not include the optional end tab 14 and is inserted between two pieces of wallboard, plywood, or any other stackable material. Upon removal of the display sign from the gap, the sign preferably returns to its original dimensions; that is, angle (theta)₂ and distance (sigma) return to their original values due to the tensioned ‘memory’ (flexibility) of the materials that the sign is manufactured from.

In the case of the alternative embodiment illustrated in FIG. 3, and as shown in FIG. 4, the sign is inserted into a gap between the top and bottom 28 of a pallet, and around a central support leg 32, such that the gap 22 in base member 10 and split return legs 24a and 24b surround the central support leg 32 of the pallet. When the display sign is removed, the sign returns to its original shape due to the tensioned ‘memory’ of the plastic material. Alternatively, and equally acceptable, the display signs of the present invention can be inserted into gaps, voids, or spaces where there is no ‘wedging effect’; that is, the height h shown in FIGS. 6 and 7 can be greater than the height (sigma) of the return leg 12. In such an instance, the display sign can simply sit on base member 10, with the base member substantially parallel to and in direct contact with the top face of the product and front display panel 2 faced toward the customer.

The display sign of the present invention can be made of any rigid yet flexible material. Preferably, the display sign can be formed from a rigid yet flexible plastic having tensioned ‘memory’ such as polystyrene, high-impact polystyrene, sintra plastic (PVC, polyvinyl chloride), coroplast (corrugated plastic), alumalite, and the like, and can be made of one material or a combination of suitable materials. It will be understood that many other materials including other plastics, vinyl, cardboard, coated cardboard, and metals such as aluminum, tin, or steel, as well as combinations thereof, can be used for the present invention without departing from the scope of the invention. The signs of the present invention can be made by die cutting, stamping, and similar processes known to those of skill in the art.

In an exemplary process, a 4×8 sheet of blank WHIP (White High Impact Polystyrene) is cut into an oversized blank approximately the size of the display sign. The image of the sign, and any associated indicia, is screen-printed directly onto the plastic blank. A computer-driven saw, such as a router, then cuts the plastic to the shape of the unfolded display sign, such as the shape illustrated in FIG. 2. The display sign is then heat-folded into the final shape with heater bars applied at specific sites, e.g. bend lines 20a, 20b, and 20c in FIG. 2, thereby softening the plastic and allowing it to be easily bent into position. The finished product is then placed in a cooling jig to allow the bends to solidify, at which point the product is complete.

The edges and folds of the display sign of the present invention can be generally sharp, or alternatively and equally acceptable, can be substantially rounded or smoothed as illustrated in FIG. 6. In a preferred embodiment of the present invention, the edges and folds are substantially rounded and/or smoothed, for reasons of safety, in order to minimize product damage which may arise if sharp edges are included, and for ease in slidably inserting and removing the display sign from the gap, void, or groove into which it has been inserted. Such rounded and/or smoothed edges can be formed during the heat-folding of the sign into its final configuration, or can be generated by any acceptable mechanical means, e.g., grinding and polishing.

In FIGS. 1-7 the components of the display sign are illustrated as being substantially rectangular in shape. In accordance with the present invention, and as mentioned previously, these components can be modified as desired into a variety of different shapes and attachments in addition to the standard rectangular shapes. FIGS. 8A-8H show schematic views of example display signs in accordance with the present invention, wherein the shapes of the components have been modified. As described above, and as shown in FIG. 8A, return leg 40 can be semi-circular in shape, with a semi-circular end-tab 42. Equally as acceptable, the end-tab need not be included, as shown in FIG. 8B wherein return leg 12 has only a smoothed or rounded terminal end. FIGS. 8C-8D illustrate acceptable embodiments wherein base member 10 has a either a front edge of substantially the same length as the bottom edge of front display panel 2 (8C), or a front edge extending some distance d beyond the end of the bottom edge of front display panel 2 (8D). FIGS. 8E-8G illustrate a few of the numerous variations of front display panel 2 in accordance with the present invention. The front display panel can be a semi-circular shape (50) as shown in FIG. 8E; a triangular shape (52) as depicted in FIG. 8F, or it can be of substantially rectangular shape (54) and extend below the front edge of base member 10 as shown in FIG. 8G. In such an embodiment, the top edge of front display panel 54 is shared with the front edge of base member 10.

A further yet equally acceptable variation of the display sign of the present invention is shown in FIG. 8H, wherein the optional end tab and the return leg are combined into curled over return tab 60. According to such an embodiment, the back edge of base member 56 can curl up into a combined return leg and end tab that curls over toward itself, as shown. An equally acceptable variation of this embodiment (not shown) would be a display sign wherein only the end tab is curled over and down towards the base member and the return leg, thereby further enhancing the ease with which the sign can be inserted into a slot or gap, and eliminating any potential jamming of the wedged sign when it is removed from the slot it has been inserted into.

A wide variety of different types of indicia and/or inserts can be used with the present invention. As one example, specific indicia, such as specific product information and pricing information, can be screen-printed directly onto the front face 3a of front display panel 2 during the manufacturing process. Other suitable indicia could be laser printed paper inserts which has an adhesive or other suitable attractive coating printed on or applied to its back surface, or that can be inserted into clear plastic pouches attached to front face 3a. Such clear plastic pouches can be attached to the entirety of front face 3a, or only a section, e.g., ½, of front face 3a. It is also envisioned that in lieu of or in addition to the above plastic inserts, tear-off sheets could be affixed to the front face of the display sign of the present invention, allowing for the inclusion of installation instructions, product information, maintenance information, etc. to be displayed which the customer can remove and take. Also contemplated are laminated signs in which a magnetically attractive coating is applied to a clear laminating film. The printed sign (on paper or any other medium) can then be sandwiched between the ferrous coated laminating film and a top layer of laminating film to provide a durable, laminated sign insert.

Further methods of modification of the display sign of the present invention with regard to the display of indicia include the use of such economical approaches as dry erasable marking systems, commonly known as ‘dry-erase’ or ‘write-erase boards’, which use erasable marking pens to provide the utility of a re-usable writing surface while eliminating the mess of chalk boards or the waste of paper. Suitable dry-erase surfaces for use with the present invention include writing surfaces made of coated paper or film, melamine, ceramic, or substantially non-tacky, non-porous, cured epoxy coating compositions and the like. Such write-erasable articles can comprise a substrate having front and rear surfaces, where the front surface is a writing surface such as described above, and the rear surface has an adhesive coating. For example, the writing surface can be a cured epoxy coating that is applied to a front surface of a flexible polyester film and subsequently cured by heating. The write-erasable article can then be attached to the front face 3a of front display panel 2 of the present invention via the adhesive coating, e.g. by laminating.

Similarly, and equally acceptable, front display panel 2 of the display sign of the present invention can also be adapted to have a facing comprising a planar material formed of a porous, resilient material adapted for releasable mounting of sheet material, such as paper, through the insert of tack materials. This resilient material layer is generally porous in nature and is adapted for insert of tack or similar elements for the mounting of sheet material to display panel 2 in a releasable manner. The resilient material layer may be formed of cork board or some similar material which permits the insertion and removal of tack members. This porous material layer can be secured to the front face 3a of front display panel 2 in a fixed manner such as through adhesion, nailing or some like manner. Additionally, the resilient material layer can otherwise be fixedly mounted within an optional frame member that surrounds the outside edges of display panel 2 through extensions or clips which form a part of the frame member.

Optionally, and equally acceptable, the display sign of the present invention can have a front display panel 2 having a receiving slot (not shown) formed between and defined by front face 3a and back face 3b of display panel 2. Advertising or promotional indicia could then be slidably inserted into the receiving slot. Such a sign would necessarily be manufactured from a transparent material such that the advertising indicia displayed could be readily seen when viewed through a substantially transparent surface. Suitable materials could include, but are not limited to, acrylic, molded acrylic, clear flexible PVC, thermoplastic rubber and Plexiglas (Registered™) (Acrylite (Registered™)/Cyrolite(Registered™). Owing to the use of such substantially transparent materials used to construct the display sign, any indicia placed within the receiving slot can be seen by retail customers on the opposite side of the transparent panel. Such an embodiment offers not only versatility in advertising and promotional information which can be displayed and changed as often as necessary, but simultaneously aids in protecting such information from being damaged or lost during movement of the sign.

While the display sign of the present invention has been described in use with stacks of construction materials such as wallboard, cement board, foam core insulation, and the pallets that such products are typically displayed upon in commercial retail settings, it is envisioned that the herein described display sign can be utilized with a variety of other stackable products that are stored on and use pallet displays, and/or are displayed away from a central racking system, including but not limited to: construction materials such as shingles, tar paper, cans of paint, cans of roofing tar, bags of cement and mortar, insulation, and wood boards; landscape materials including edging blocks, pavers, landscape bricks, bricks, flagstones, and stones; garden materials such as bags of dirt, bags of fertilizer, bags of grass seed, bags of herbicide, bags of pesticide, and lawn equipment such as lawn mowers and lawn edgers; automotive and automotive repair components such as engines, axels, transmissions, brake fluid, oil cans, and windshield washer fluid; and food items such as bulk can goods, bulk baking goods (e.g., flour), bulk boxed/packaged food products (e.g., cereal), and alcohol. Other envisioned uses for the display sign of the present invention include any marketing or display circumstance wherein the sign can be wedged into a slot or void, or placed on top of a stack of merchandise. For example, it is envisioned that the display sign of the present invention can be reduced in size and inserted into slots between display shelves in grocery or other retail stores, or it could be inserted into a space that is itself a part of the item being displayed, such as the gap between the freezer and the cooler sections of a refrigerator.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Fabrication of Display Sign

A 4 foot×8 foot sheet of ⅛ inch thick blank WHIPs (white high impact polystyrene) was first cut into an oversize blank of approximate size of the finished product, approximately 24 inches×30 inches. The section to be the front display panel was then screen printed on the front and the back face with product information and instructions for use of the display sign, respectively. A computerized, machine driven router saw (CNC Router; e.g. VR 408 CNC Router from Komo Machine Inc., Sauk Rapids, Minn.) was then used to cut the blank to the shape of the display sign, as shown in FIG. 2. The sign was then bent and folded at the appropriate places (e.g., at seams 20a, 20b, and 20c in FIG. 2) with heater bars, and put into a cooling jig to cool. The finished product had the following dimensions:

front display panel: 17.0″ wide×11″ high;

base member: 9.0″ wide×6″ long;

return leg: 9.0″ wide×6.75″ long;

end tab: 9.0″ wide×0.75″ long;

angle (theta)₁ (angle between front display panel and base member): about 80°;

angle (theta)₂ (angle between base member and return leg): about 40°;

height (sigma) about 6.3 cm; and

offset distance, d: about 4.0″ from each side.

### Example 2

### Fabrication of a Display Sign Having Split Return Legs and Base Member

A 4 foot×8 foot sheet of ⅛ inch thick blank, WHIPs (white high impact polystyrene) was first cut into an oversize blank of approximate size of the finished product, approximately 24 inches×30 inches. The section to be the front display panel was then screen printed on the front and the back face with both product information (front) and instructions for use and handling of the display sign (back). A computerized, machine driven router saw (CNC Router; e.g. VR 408 CNC Router from Komo Machine, Inc., Sauk Rapids, Minn.) was then used to cut the blank to the shape of the display sign, as shown in FIG. 4. The sign was then bent and folded at the appropriate places (e.g., at seams 20a, 20b, and 20c in FIG. 4) with heater bars, and put into a cooling jig to cool. The finished product had the following dimensions:

front display panel: 24.0″ wide×18.5″ high;

base member: 9.0″ wide×6″ long;

return leg 1: 3.5″ wide×6.75″ long;

return leg 2: 3.5″ wide×6.75″ long;

gap width: 2.0″;

end tabs: 3.5″ wide×0.75″ long (each);

angle (theta)₁ (angle between front display panel and base member): about 80°;

angle (theta)₂ (angle between base member and return leg): about 40°;

height (sigma) about 6.3 cm; and

offset distance, d: about 4.0″ from each side.

### Example 3

### Use of Display Sign in Wallboard Dead Stack Slot

A display sign in accordance with Example 1 above was inserted in the gap between the risers of multiple tiers of gypsum wallboard. In doing so, the height (sigma), the distance from the top of the base member to the joint at the junction of the return leg and end tab, was decreased, causing a “pinching effect” and holding the sign in place. FIG. 6 illustrates such a placement, from the customer's viewpoint, looking at the front display panel.

### Example 4

### Use of Display Sign Having Split Return Legs in Wallboard Dead Stack

A display sign in accordance with Example 2 above was inserted in the gap between the risers of multiple tiers of gypsum wallboard, and simultaneously around a 1¾″ support riser between the tiers, such that the gap in the base member and between the two return legs was substantially surrounding one end of the support riser. In doing so, the height (sigma), the distance from the top of the base member to the joint at the junction of the return leg and end tab, was decreased, causing a “pinching effect” and holding the sign in place. Simultaneously, the placement of the base member and the two return legs around the support riser prevented any horizontal or “side-to-side” movement of the display sign.

### Example 5

### Use of Display Sign on the Top of a Wallboard Dead Stack.

A display sign in accordance with Example 1 above was placed on top of a stack of vertically aligned wallboard on display, such that the base member was substantially in contact with and parallel to the top face of the uppermost wallboard on the stack.

All of the apparatus disclosed and claimed herein can be made and executed without undue experimentation in light of the present disclosure. While the apparatus of this invention have been described in terms of preferred embodiments, it will be apparent to those of skill in the art that variations may be applied to the apparatus and in the steps or in the sequence of steps of the methods described herein without departing from the concept and scope of the invention. All such similar substitutes and modifications apparent to those skilled in the art are deemed to be within the scope and concept of the invention.

1. A display sign comprising:
a front display panel having a first face lying in a plane defining a lower edge, first and second laterally opposed end edges, and an upper edge;
a base member having a top face lying in a plane substantially normal to and intersecting the lower edge of the front display panel and defining the lower edge of the front display panel for a substantial portion of the lateral distance between the laterally opposed ends of the display panel; and
a return leg having a terminal end and a proximal end substantially parallel and laterally opposed, and first and second laterally opposed edges, wherein the leg extends upwardly from the top face of the base member with a substantial portion thereof spaced horizontally from and facing towards the front display panel at an angle (theta)₂.

2. The display sign of claim 1, further comprising an end tab, wherein the end tab has a front edge, first and second laterally opposed end edges, and a back edge, and wherein the back edge of the end tab substantially intersects and substantially co-defines the terminal end of the return leg.

3. The display sign of claim 1, wherein the angle (theta)₂ is between about 1° and about 90°.

4. The display sign of claim 1 wherein the sign is made of plastic.

5. The display sign of claim 4, wherein the plastic is sintra, polystyrene, coroplast.

6. A display sign comprising:
a front display panel having a first face lying in a plane defining a lower edge, first and second laterally opposed end edges, and an upper edge;
a base member having a top face lying in a plane substantially normal to and intersecting the lower edge of the front display panel and defining the lower edge of the front display panel for a substantial portion of the lateral distance between the laterally opposed ends of the display panel; and
at least two return legs, each having a terminal end, a proximal end and laterally opposed edges, wherein the leg extends upwardly from the top face of the base member with a substantial portion thereof spaced horizontally from and facing towards the front display panel at an angle (theta)₂,
wherein the base member and the return legs have a gap.

7. The display sign of claim 6, further comprising at least one end tab having a front edge, first and second laterally opposed end edges, and a back edge, and wherein the back edge of the end tab substantially intersects and substantially co-defines the terminal end of the return leg.

8. The display sign of claim 6, wherein the angle (theta)₂ is between about 1° and about 90°.

9. b2The display sign of claim 6, wherein the sign is made of plastic.

10. The display sign of claim 9, wherein the plastic is sintra, polystyrene, or coroplast.

11. A display system for displaying advertising material away from the surface of the product, comprising:
(a) a void between at least two risers; and
(b) a display sign comprising:
a front display panel having a first face lying in a variably vertical plane and defining a lower edge, first and second laterally opposed end edges, and an upper edge;
a base member having a top face lying in a substantially horizontal plane substantially normal to and intersecting the lower edge of the front display panel and defining the lower edge of the front display panel for a substantial portion of the lateral distance between the laterally opposed ends of the display panel; and
a return leg having a terminal end, a proximal end and laterally opposed edges, wherein the leg extends upwardly from the top face of the base member with a substantial portion thereof spaced horizontally from and facing towards the front display panel at an angle (theta)₂.

12. The display system of claim 11, further comprising an end tab having a front edge, first and second laterally opposed end edges, and a back edge, first and wherein the back edge of the end tab substantially intersects and substantially co-defines the terminal end of the return leg.

13. The display system of claim 11, wherein the base member and the return leg have a gap extending at least partially between them.

14. The display system of claim 11, wherein the angle (theta)₂ is between about 1° and about 90°.

15. The display system of claim 11, wherein the sign is made of plastic.
